(19) United States
(12) Patent Application Publication
(10) Pub. No.: US 2009/0188397 A1
(43) Pub. Date: Jul. 30, 2009

(54) Juicing Knife

(76) Inventor: Ohad Holzberg, Kiryat Tivon (IL)

Correspondence Address: The Law Office of Michael E. Kondoudis, PC, 888 16th Street, N.W., Suite 800, Washington, DC, 20006, US

(21) Appl. No.: 12/307,846

(22) PCT Filed: Jul. 10, 2007
(86) PCT No.: PCT/IL07/00862

§ 371 Date: Jan. 7, 2009

Related U.S. Application Data
(60) Provisional application No. 60/819,395, filed on Jul. 10, 2006.

(51) Int. Cl. A23N 1/02

(52) U.S. Cl. 99/509

(57) ABSTRACT

Presented herein is a juicing knife for extracting the juice from a citrus fruit, said knife comprising a handle, a blade, rigidly attached to the handle, wherein the blade has a substantially curved section that forms a scraping arc, and a plug that surrounds the base of the blade, wherein inserting the blade through the full length of the fruit until the plug abuts against the fruit and the blade exits through the bottom of the fruit, and subsequently rotating the blade within the fruit causes juice to be expressed and drained out of the fruit through the exit point of the blade. Embodiments of the present invention may further comprise a juicing funnel adapted to receive a fruit from which juice is to be extracted by the juicing knife.

### CROSS REFERENCE TO RELATED APPLICATIONS

This Application is a National Stage of an International Application No. PCT/IL2007/000862, filed Jul. 10, 2007, which is incorporated herein by reference in its entirety, which in turn claimed the benefit of U.S. Provisional Patent Application 60/819,395, filed Jul. 10, 2006, which is further incorporated herein by reference in its entirety.

### FIELD OF THE INVENTION

This invention relates generally to kitchen utensils, and specifically to devices used to extract juice from fruits and vegetables.

### BACKGROUND OF THE INVENTION

A ripe lemon is bursting with juice. This juice has many uses, both culinary and medicinal.

For example, in addition to using fresh lemons for traditional lemonade and as a garnish on grilled fish, fresh lemon juice is also a key ingredient in a myriad of recipes, including recipes for sauces, cakes, salsas, and drinks.

Lemons also have many health benefits. Lemons have a long history of protecting sailors from scurvy, thanks to their high content of vitamin C, a component vital to maintaining a strong immune system. In addition, lemons are also touted as having not only antioxidant and anti-cancer properties but also antibiotic properties.

In order to get the greatest benefit and the best flavor, freshly squeezed lemon juice must be used. There are a number of options for expressing this fresh juice. A juicing machine, useful for juicing quantities of fruits, can be expensive and cumbersome, and is hardly ideal for extracting the spoonful of juice required by, for example, a bowl of fresh salsa. More minimally, one can use a hand-held press or squeezer, or even squeeze the lemon by hand, which may be a messy, inefficient, and wasteful process.

Other options include devices that are inserted into the top of a citrus fruit and twisted while also pressing and squeezing the fruit, such as is described in U.S. Pat. No. 4,889,044, which is incorporated by reference in its entirety herein, and discloses a device enabling the user to extract and drink juice directly from the fruit itself rather than to express juice into a container that is then available for preparing, for example, a recipe. A big drawback to this type of device is that the twisting and squeezing actions often cause the fruit to tear apart, allowing the juice to spill everywhere.

None of the above solutions and patents, taken either singularly or in combination, is seen to disclose a device for extracting juice from a citrus fruit, and for catching and directing that juice to a desired location, that is quick and easy to insert, is simple to operate, and that offers maximum juice extraction and minimal spillage, as will subsequently be described and claimed in the instant invention.”

### SUMMARY OF THE INVENTION

Presented herein is a juicing knife for extracting the juice from a citrus fruit that allows the user to express the juice easily, efficiently, quickly, and thoroughly, while ensuring that substantially all of the juice is removed from the fruit. A juicing knife of the present invention comprises a handle, a plug, and a blade.

A feature of the present invention is the specially curved knife blade that enables the juice to be removed from the citrus fruit without cutting apart the fruit, which significantly reduces the chances of spilling the acidic, sticky juice everywhere.

Another feature of the juicing knife of the present invention is that the blade is inserted through the full length of the fruit until the plug abuts against the fruit and the blade exits through the bottom of the fruit. Thus, when the user rotates the handle, which allows the curved blade to express the juice, the juice is able to drain out of the bottom of the fruit via the opening created by the blade.

The device further allows the user to conveniently catch the extracted juice and direct it into a container or other destination. Some embodiments of the present invention may additionally comprise a juicing funnel, which further enhances this feature.

Accordingly, a juicing knife of the present invention for extracting the juice from a citrus fruit is provided, said device comprising a handle, a blade, rigidly attached to the handle, wherein the blade has a substantially curved section that forms a scraping arc, and a plug that surrounds the base of the blade, wherein inserting the blade through the full length of the fruit until the plug abuts against the fruit and the blade exits through the bottom of the fruit, and subsequently rotating the blade within the fruit causes juice to be expressed and drained out of the fruit through the exit point of the blade.

The juicing knife may further comprise a juicing funnel adapted to receive a fruit from which juice is to be extracted by the juicing knife.

Additionally the plug substantially prevents the juice from exiting the fruit at the points where the plug abuts against the fruit.

Additionally, the plug is a rounded piece made from at least one of the following materials that is suitable for use with food: plastic, rubber, silicon.

Additionally, the shape of the plug protects the entry point of the blade into the fruit from further tearing.

Additionally the juicing funnel further comprises grasping areas for facilitating the grasping of the juicing funnel and a fruit seated therein.

Additionally, the juicing knife may further comprise a net for fitting over the bottom opening of the juicing funnel to catch seeds and other solid matter that is extracted from the fruit.

Additionally, the juicing knife may further comprise covers for the bottom opening and the mouth of the juicing funnel to enable storage of at least one of a fruit and the juice extracted therefrom.

Additionally, the juicing funnel may be constructed from flexible material.

### BRIEF DESCRIPTION OF THE FIGURES

The subject matter regarded as the invention will become more clearly understood in light of the ensuing description of embodiments herein, given by way of example and for purposes of illustrative discussion of the present invention only, with reference to the accompanying figures, wherein

FIG. 1 is a perspective view of juicing knife according to an embodiment of the present invention;

FIG. 2 is a front view of the juicing knife of FIG. 1;

FIG. 3 is a side view of the juicing knife of FIG. 1;

FIG. 4 is a side view of the juicing knife of FIG. 1 with a lemon in place on the knife blade;

FIG. 5 is a perspective view of a juicing knife and a lemon, seated in a juicing funnel according to another embodiment of the present invention; and

FIG. 6 is a perspective view of the juicing funnel of FIG. 5.

The figures together with the description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

Presented herein is a juicing knife 10 for removing or expressing the juice from a lemon 50 or other citrus fruit. Such a juicing knife 10 allows the user to express the juice efficiently, quickly, and thoroughly, in such a fashion that substantially all of the juice is removed from the fruit. A feature of the present invention is the specially curved knife blade 30 that enables the juice to be removed from a lemon 50 without cutting apart said lemon 50, thereby substantially preventing or drastically reducing the chances of spilling the acidic, sticky juice everywhere.

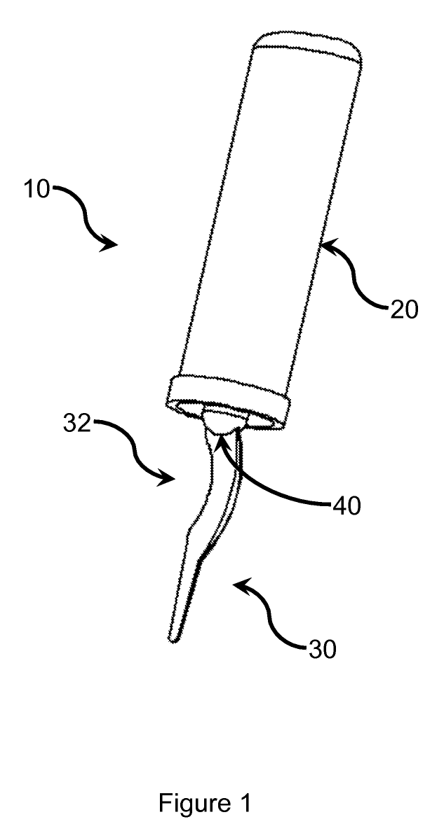

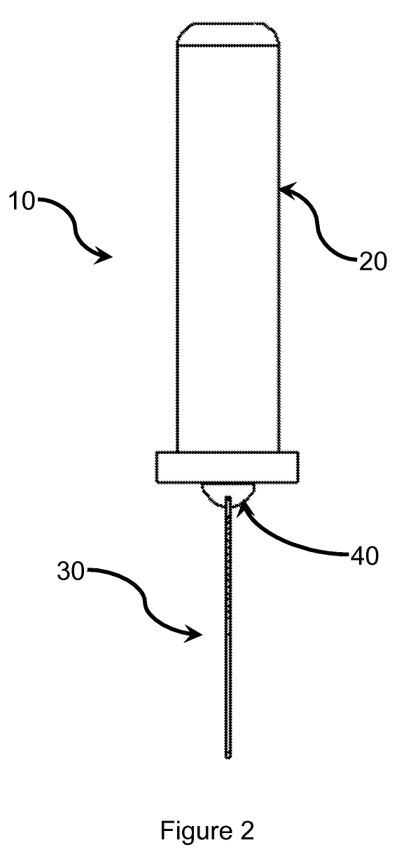

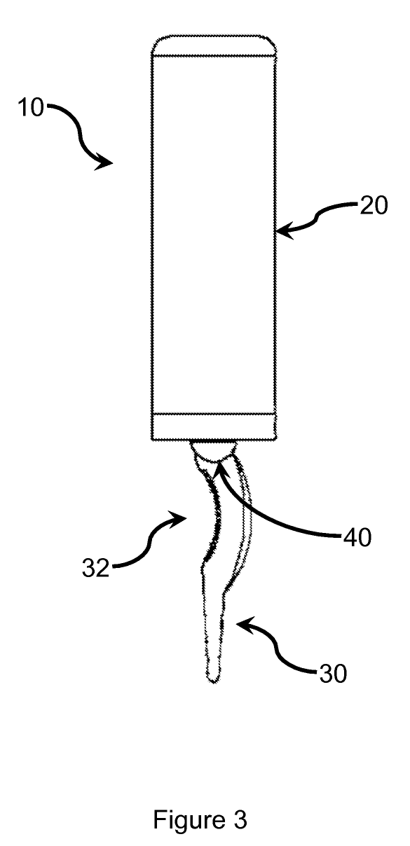

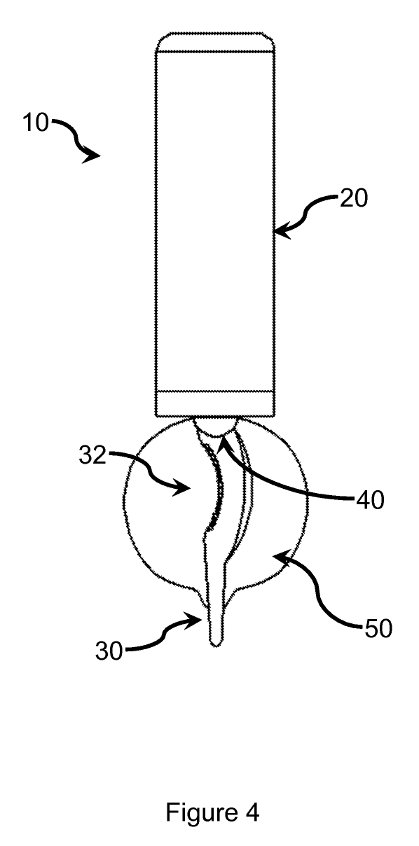

In order to better understand the present invention, reference is made to the accompanying drawings, wherein FIGS. 1, 2, and 3 show an embodiment of the present invention from various directions, and FIG. 4 describes an embodiment of the present invention, wherein the knife blade has been inserted into a lemon.

It is to be understood that an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting and is for descriptive purpose only.

The principles and uses of the teachings of the present invention may be better understood with reference to the accompanying description, figures and examples.

It is to be understood that the details set forth herein should not be construed as limiting any applications of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein, is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not to be construed as there being only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

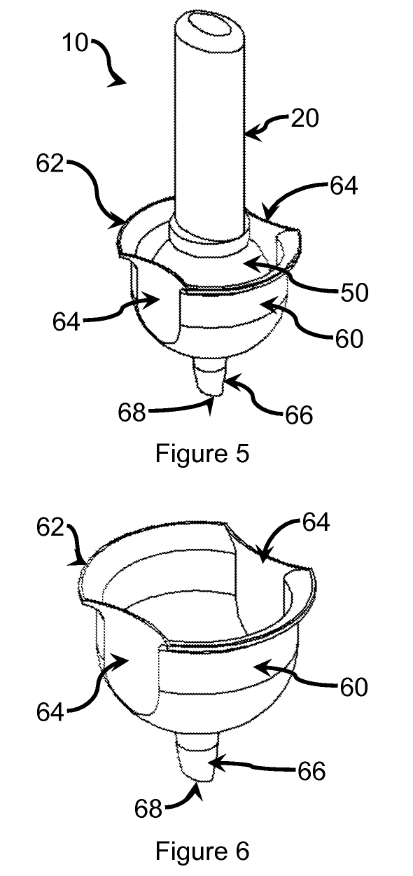

According to embodiments of the present invention, a juicing knife 10 for expressing juice from citrus fruits such as, for example, lemons 50, comprises a handle 20, a plug 30, and a blade 40, and may additionally comprise a juicing funnel 60, which enables catching and directing the extracted juice, as shown in FIGS. 5 and 6.

According to embodiments of the present invention, handle 20 allows the user to firmly grasp juicing knife 10 and may be constructed from any type of sturdy material that provides a long-lasting, robust graspable handle 20. According to some embodiments of the present invention, handle 20 may also be contoured in order to further enhance the user's ability to grasp and securely hold handle 20.

According to embodiments of the present invention, a blade 30 is rigidly attached to handle 20, as is known in the art. A portion of blade 30 has a substantially curved section that forms a scraping arc 32. According to embodiments, the outer edge of arc 32 may additionally have a coarse or irregular surface. Additionally, the farthest end of blade 30 is sufficiently sharp or pointed to piece the rind of a lemon 50 or other fruit from which fruit is to be expressed.

Blade 30 according to embodiments of the present invention is made from materials that are suitable for use with food.

Attached to handle 20, and surrounding the base of blade 30, is a plug 40.

According to some embodiments of the present invention, plug 40 may be a rounded piece made from materials that are suitable for use with food including, inter alia, plastic, rubber, and silicon. It is understood that other materials may also be used without departing from the scope of the invention. It is also understood that other materials and constructions could be used for plug 40 in order to provide a sturdy plug 40 for juicing knife 10.

Plug 40 functions to stop the expressed juice from exiting through a first hole created when blade 30 of juicing knife 10 is inserted into a lemon 50 or other fruit from which juice is to be expressed. Thus, plug 40 substantially prevents the juice from exiting the fruit at the points where plug 40 abuts against the fruit.

The shape of plug 40 may also minimize any damage that may be cause by handle 20 or blade 30 when juicing knife 10 is rotated within lemon 50 and substantially prevents the entry point of blade 30 into the fruit from sustaining further tearing or other damage.

According to some embodiments of the present invention, juicing knife 10 may further comprise a juicing funnel 60 adapted to receive a lemon 50 or other fruit from which juice is to be extracted by juicing knife 50, as is shown in FIGS. 5 and 6.

Such a juicing funnel 60 may comprise a bowl in which, for example, lemon 50 may be placed, a mouth 62 on the uppermost edge of the bowl, a stem 66 protruding down from the center of the bottom of the bowl that terminates in a bottom opening 68.

Disposed on two sides of juicing funnel 60 facing each other there may be two grasping areas 64, which facilitate the grasping of juicing funnel 60, and a fruit seated therein, and further enabling the user to securely grasp a lemon 50 or other fruit from which juice is to be expressed. This feature may also help the user keep his hands clean while using juicing knife 10.

According to some embodiments of the present invention, juicing funnel 60 may be constructed from flexible material. According some other embodiments, only a portion of juicing funnel 60 may be flexible. For example, the areas between grasping areas 64 may flex. It is understood, however, that other configurations and constructions could be used for juicing funnel 60 without departing from the scope of the invention.

According to some embodiments of the present invention, a net may be provided for fitting over bottom opening 68 of juicing funnel 60 in order to catch seeds, pulp, and other solid matter that might be extracted along with the juice. Some embodiments of the present invention may further comprises covers for the bottom opening and the mouth of juicing funnel 60 to enable storage of at least one of a lemon 50 or other fruit from which juice is to be expressed and the juice expressed therefrom.

In order to more fully describe the present invention, the following describes a mode of use.

According to embodiments, a user may hold a lemon 50 in one hand and grasp juicing knife 10 by handle 20 in the other hand. For greater convenience, the user should hold lemon 50 so that the flat end of lemon 50 is facing toward juicing knife 10. For purposes of this document, the flat end of a lemon 50 may be defined as the somewhat flat area of the fruit that contains the trace of the stem that attached lemon 50 to a tree.

Blade 30 of juicing knife 10 may be inserted into lemon 50. While it is preferred that blade 30 enter the lemon 50 at the flat end, it is also possible to insert blade 30 of juicing knife 10 into another location on lemon 50. Blade 30 may then be pushed through the full length of lemon 50 until plug 40 abuts against lemon 50 and blade 30 exits through the bottom of lemon 50.

In order to achieve the most productive result, the user should position juicing knife 10 such that when blade 30 is pushed through lemon 50, the end of blade 30 exits at a location substantially opposite to the location where blade 30 entered lemon 50. When properly inserted into lemon 50, plug 40 abuts against the flat end of lemon 50.

According to embodiments equipped with a juicing funnel 60, the user may pass lemon 50 with blade 30 inserted therein through mouth 62 into the bowl of juicing funnel 60, such that the tip of blade 30 is pointing towards or even jutting into stem 66.

Once juicing knife 10 is in place, and lemon 50 is seated in juicing funnel 60 as applicable, the user may use handle 20 to rotate blade 30 of juicing knife 10 within lemon 50, either clockwise or counterclockwise. As each individual juice sac, or piece of pulp, comes in contact with the outer edge of arc 32, arc 32 pierces said juice sac, thereby releasing the juice contained therein, and causing the juice to be expressed.

As juicing knife 10 rotates, the released juice drains down through lemon 50, and exits out through the exit point created by blade 30 of juicing knife 10. Plug 40 ensures that the juice does not exit from the first hole created by juicing knife 10. A container placed under lemon 50 will catch the expressed juice. Where a juicing funnel 60 is utilized, bottom opening of juicing funnel 60 may be set over the container to assist in more precisely catching the juice.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A juicing knife for extracting the juice from a citrus fruit, said knife comprising:
a handle;
a blade, rigidly attached to the handle, wherein the blade has a substantially curved section that forms a scraping arc; and
a plug that surrounds the base of the blade,
wherein inserting the blade through the full length of the fruit until the plug abuts against the fruit and the blade exits through the bottom of the fruit, and subsequently rotating the blade within the fruit causes juice to be expressed and drained out of the fruit through the exit point of the blade.

2. The juicing knife of claim 1, further comprising a juicing funnel adapted to receive a fruit from which juice is to be extracted by the juicing knife.

3. The juicing knife of claim 1, wherein the plug substantially prevents the juice from exiting the fruit at the points where the plug abuts against the fruit.

4. The juicing knife of claim 3, wherein the plug is a rounded piece made from at least one of the following materials that is suitable for use with food: plastic, rubber, silicon.

5. The juicing knife of claim 1, wherein the shape of the plug protects the entry point of the blade into the fruit from further tearing.

6. The juicing knife of claim 2, wherein the juicing funnel further comprises grasping areas for facilitating the grasping of the juicing funnel and a fruit seated therein.

7. The juicing knife of claim 2, further comprising a net for fitting over the bottom opening of the juicing funnel to catch seeds and other solid matter that is extracted from the fruit.

8. The juicing knife of claim 2, further comprising covers for the bottom opening and the mouth of the juicing funnel to enable storage of at least one of a fruit and the juice extracted therefrom.

9. The juicing knife of claim 2, wherein the juicing funnel is constructed from flexible material.
